(19) United States
(12) Patent Application Publication
(10) Pub. No.: US 2011/0024229 A1
(43) Pub. Date: Feb. 3, 2011

(54) Sound Insulating and Absorbing Automotive Foot Mat Structure

(76) Inventor: Ming-Shun Yang, Taipei City (TW)

Correspondence Address: LEONG C. LEI, PMB # 1008, 1839 YGNACIO VALLEY ROAD, WALNUT CREEK, CA, 94598, US

(21) Appl. No.: 12/194,126

(22) Filed: Aug. 19, 2008

(51) Int. Cl. G10K 11/168

(52) U.S. Cl. 181/294

(57) ABSTRACT

A sound insulating and absorbing automotive foot mat structure includes at least an upper water-proof layer and a lower sound absorbing layer. The upper water-proof layer is configured as a foaming material, and the lower sound absorbing layer is configured as needle-bonded cotton having a sound absorbing effect. Above the water-proof layer, it can be even added with a blanket and thermoplastic elastomer. Each layer of parts is attached and is formed integrally via a die-cast technology, allowing the mat to be provided with multiple functions of sound insulating, vibration reduction, sound absorbing, water-proofing, light weight and inexpensive manufacturing cost.

### BACKGROUND OF THE INVENTION

a) Field of the Invention

The present invention relates to a sound insulating and absorbing automotive foot mat structure, and more particularly to a foot mat structure which includes an automotive foot mat and an automotive carpet formed by the foot mat structure, such that when a foot mat is made, the foot mat can be placed on the automotive carpet to be stepped by users without sliding, and dirt and sand that are stained on shoe soles can be collected without smudging the automotive carpet. In addition, being applied to either the foot mat or the automotive carpet, a design of material itself will achieve functions of effectively preventing noise at a chassis from entering into an automobile, water-proof, sound absorbing and being shaped easily.

b) Description of the Prior Art

Normally, after an automobile has been manufactured, a floor in the car will be paved with a carpet. As this carpet has a good sense of texture and is expensive, it is provided with a decoration effect for beautifying the sense of texture in the car. However, to keep the automotive carpet clean, a car owner will always pave on the automotive carpet with other foot mats at places stepped by passengers. A set of the ordinary movable foot mats that can be cleaned and washed conveniently includes four pads which can be paved on the floors of a driver's seat, a deputy's seat and two rear passenger seats, to protect the high class automotive carpet in an underlayer. As the ordinary automotive foot mat is simply paved on the floor in the car, it is easy to cause slide between the foot mat and the carpet due to the stepping of passengers, and especially that the foot mat at the driver's place can thus cause a concern in driving safety, which needs to be improved.

It is worth to be mentioned that a primary reason to cause poor sound insulating in the car is that the sound is propagated via the impetus between air molecules. On the other hand, a sound frequency is directly related to a vibration speed of a sound source, and an automobile structure is closely related to the thickness of its metal shell. In addition, noise is caused by an irregular change of the sound frequency, allowing the sound frequency that is listened to be vibrating and disorderly. Therefore, a human brain will be very fatigued and repulsive, thereby making a listener to feel very uncomfortable and unpleasant. As for sound absorption, it is a phenomenon of consuming sound energy, referring to that as a sound wave is vibrating and rubbing in a material, sound energy at some frequency is consumed. Objects of various materials have different capabilities of reflection and absorption to the sound wave in different frequencies. When the reflection sound is too strong, it can be processed by way of sound absorbing, which uses a special kind of passive material to change a direction of the sound wave or friction inside a porous material to attenuate the energy of sound that passes therethrough. Sound absorption cotton processes the sound at a medium and high frequency, accomplishing the sound absorption by diluting the energy at a medium and high frequency.

Under an existing condition, most of the noise in the car is transmitted through a suspension system, a chassis, a trunk and doors; whereas, wind shear sound of a car shell generated while driving the car in high speed, or scrooping sound occurred when four wheels are driven can be heard in a driver's chamber due to ill sound insulation. A sound absorbing cotton pad which is paved on a bottom shell in the car when manufacturing the car is made from polypropylene and polyester, so as to enhance vibration-proof, moisture-proof and sound absorbing treatments to a central underplate and a rear compartment underplate, with the most essential function for dealing with vibration and resonance of the metal work piece when the car is driven in high speed, road noise is transmitted from tires, and resonant sound pressure is transmitted to the rear compartment from sound of exhaust. More particularly, this kind of noise will especially cause people in the car to be weary when driving a long distance.

The conventional automotive carpet or foot mat is provided with a limited sound absorbing and insulating effect, generally due to a feature of material itself. A foaming material itself is provided with independent bubbles, and is characterized by advantages of water-proofing, thermal insulating, warm keeping, buffering, shock-absorbing, dewdrop-proofing, moisture-proofing, light-weight and fuel-saving. In addition, the sound insulating effect is very good. On the other hand, features of the sound absorbing cotton include (1) the material is flame retardant (can be added with a fire retarding agent); (2) it is provided with a sound insulating and thermal insulating function; (3) it can block all kinds of noise; (4) it can reflect the frequency of sound source; and (5) it can prevent plane vibration. Therefore, if the automotive carpet or foot mat is assembled with the foaming material, the effects of sound insulating and sound absorbing of the car can be effectively augmented. However, there has not been a design that the foaming material of good water-proofing and sound insulating effects is assembled with the sound absorbing cotton of the excellent sound absorbing effect.

A conventional foot mat used in cars has been disclosed in a U.S. Pat. No. 6,261,667, “Mat Used in Cars,” by the present inventor. The mat structure of the invention is composed of an upper polyester fabric layer, a middle polyvinylchloride layer and an under net lining. The mat can collect dirty water, rain and mud, thereby facilitating cleaning without smudging the carpet, and can effectively achieve the function of skid-proofing by fixing with the automotive carpet.

In terms of the foot mat used in the cars, conditions of the good mat considered by manufacturers include:
1. The weight of the foot mat should be light after being manufactured. To meet the environmental protection benefit of saving fuel consumption, all automotive parts have been manufactured toward light weight; therefore, if a part or accessory can be replaced by the light-weight material, it will be a major contributor to the fuel saving of automobiles.
2. The foot mat should be sound insulating, sound absorbing and water-proof. The automotive foot mat is paved on the automotive carpet, and is formed into a three-dimensional space to serve as an inner lining of the car, after being manufactured. The foot mat is also provided with the function of isolating the noise at the chassis from transmitting into the car, so as to intensify the quietness effect in compartments.
3. The manufacturing cost should be low. A purpose of mass production is to increase marketing competitiveness, which inevitably will reduce the manufacturing cost as much as it can. Therefore, the manufacturing process should be carefully considered and the material should be selected rigorously, so as to reduce the price in addition to increasing the function that the requirement of cheap price and good quality can be implemented.

### SUMMARY OF THE INVENTION

The primary object of the present invention is to provide a sound insulating and absorbing automotive foot mat structure, which can be easily produced, and an entirety of which can achieve functions of light weight, water-proofing, sound insulating, sound absorbing and skid-proofing.

Another object of the present invention is to provide a sound insulating and absorbing automotive foot mat structure, an upper layer of which can be also assembled with a blanket material having an extremely good sense of touch, so as to improve the sense of touch and texture.

Still another object of the present invention is to provide a sound insulating and absorbing automotive foot mat structure, an upper layer of which can be also assembled with thermoplastic elastomer (TPE) to provide a soft and comfortable sense of stepping.

Yet still another object of the present invention is to provide a sound insulating and absorbing automotive foot mat structure, wherein in addition to that the mat body can be manufactured into the foot mat in a shape of a single block, allowing the foot mat to be taken out for washing conveniently; the mat body can be also made into a whole piece of automotive carpet, thereby effectively absorbing noise transmitted due to vibration of a chassis and preventing sound from entering into compartments such that the compartments can be more tranquil.

Accordingly, a sound insulating and absorbing automotive foot mat structure of the present invention is assembled by at least a foaming material, which is located at an upper water-proof layer; and sound absorbing cotton, which belongs to a lower sound absorbing layer. These two layers of parts are attached and made integrally via a die-cast technology, forming an indented disc-shape body on the foot mat, with a bottom plane of the disc-shape body being formed with skid-proof grooves. The present invention uses the sound absorbing layer to absorb most of noise transmitted from a chassis, and then uses a sound insulating layer to effectively block noise outside of a car and then uses the sound absorbing layer to disintegrate. The sound insulating layer is provided with the water-proof effect and controls the noise not to be transmitted upward into compartments. Above the foaming material at the upper layer of the automotive foot mat, it can be further installed with a blanket or thermoplastic elastomer to increase a sense of texture; whereas, a bottom of the sound absorbing layer at the lower layer of the automotive foot mat is formed with bumps and air grooves, and a bottom surface of the lower layer material can be added with the thermoplastic elastomer, which has skid-proof effect to form the skid-proof material of the mat, enabling an entirety of the mat to achieve multiple functions of sound insulating, vibration buffering, sound absorbing, water-proofing, light weight and inexpensive manufacturing cost.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional view of an automotive foot mat of the present invention.

FIG. 2 shows a schematic view of a structure of an automotive foot mat of the present invention that is not shaped.

FIG. 3 shows a transversal cutaway view of the present invention.

FIG. 4 shows a schematic view of a manufacturing process of laminating a bottom layer with a skid-proof material, according to the present invention.

FIG. 5 shows a transversal cutaway view of a bottom layer of the present invention, after being laminated with a skid-proof material.

FIG. 6 shows a schematic view of another embodiment of laminating a bottom layer with a skid-proof material, according to the present invention.

### DETAILED DESCRIPTION OF THE PREFERRED EMBODIMENTS

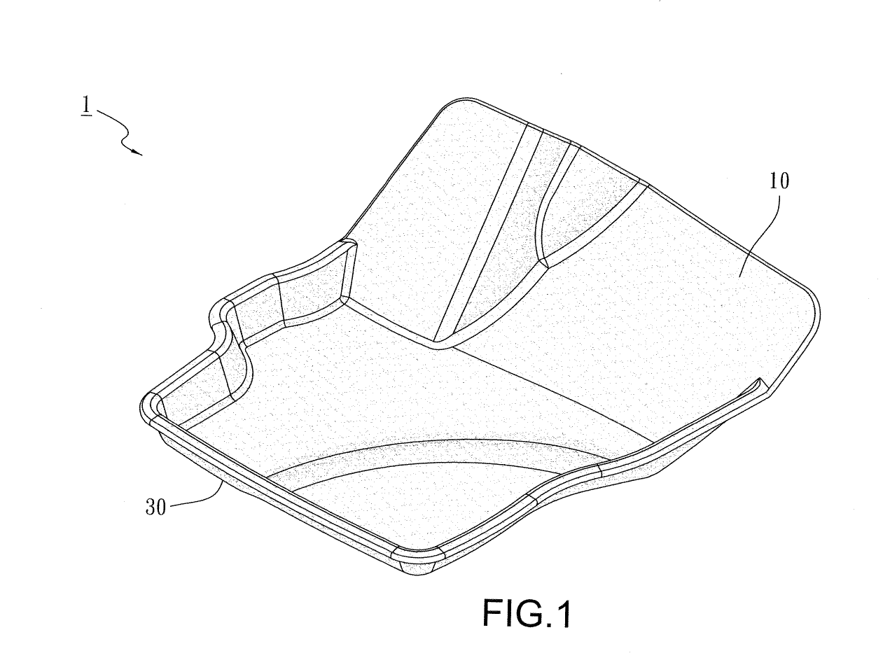

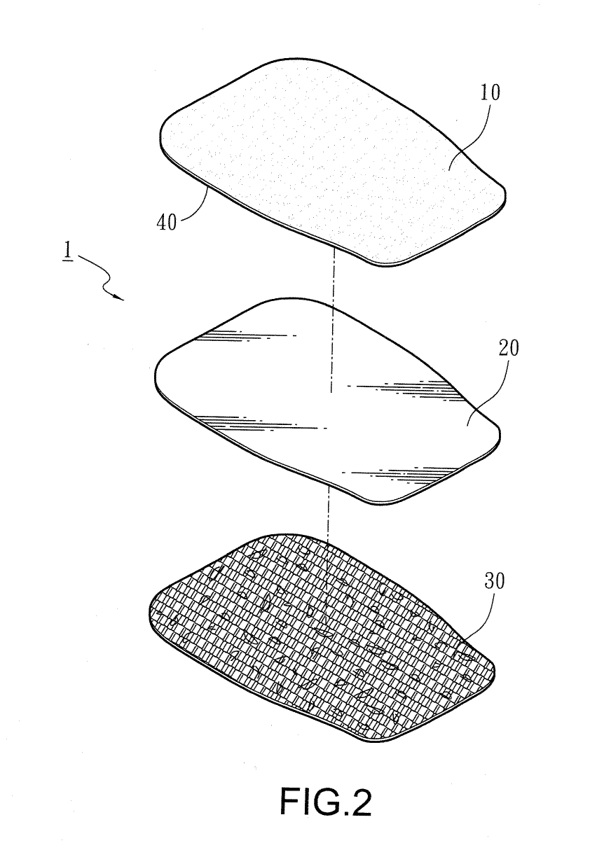

Referring to FIG. 1 and FIG. 2, taking a production of an automotive sound insulating and absorbing foot mat as an example, the present invention comprises at least a foaming material 20 of water-proof layer and a sound absorbing layer 30 which is provided with needle-bonded cotton having a sound absorbing effect. The water-proof layer is located at an upper layer and the sound absorbing layer is located at a lower layer. Each layer of parts is attached and is formed integrally via a die-cast technology, allowing the mat to be provided with multiple functions of sound insulating, vibration reduction, sound absorbing, water-proofing, light weight and inexpensive manufacturing cost. Above the water-proof layer, it can be even added with a blanket and thermoplastic elastomer.

In this embodiment of present invention, the foot mat includes a blanket 10 at a top layer, a foaming material 20 at a middle layer and a bottom sound absorbing layer 30. The aforementioned top blanket layer 10 can be made from polypropylene, polyester, nylon, polyvinyl chloride, plastic or thermoplastic polyolefin (TPO); whereas, the aforementioned middle layer of foaming material 20 can be made from low density polyethylene (LDPE), polyethylene (PE) or ethylene vinyl acetate (EVA). The foaming material 20 itself is provided with individual foaming bubbles, and is characterized by advantages of water-proofing, thermal insulating, warm keeping, vibration buffering, dewdrop-proofing, moisture-proofing, light weight and fuel-saving. In addition, the foaming material 20 is provided with an excellent sound insulating effect, and the material itself is further provided with features of firmness, light foaming material and good water-proofing, as well as with functions of sound insulating and vibration buffering. The aforementioned bottom sound absorbing layer 30 can be made of needle-bonded cotton with a sound absorbing effect, which is able to absorb noise from a central underplate in a compartment and from a rear compartment underplate, as well as is moister-proof. The most primary function is to deal with vibration and resonance of a metal work piece when the car is running in high speed, road noise transmitted in from tires, and resonant sound pressure transmitted into a trunk from sound of exhaust.

After preparing the top blanket layer 10 of the foot mat of the present invention, a rear side is implemented with a glue layer 40; next, the middle layer of foaming material 20 is attached, with a thickness of about 2-5 mm; and then, the bottom sound absorbing layer 30 is attached via glue or flame melting, with a thickness of about 2-5 mm; finally, the automotive foot mat 1 as shown in FIG. 1 is formed integrally via a die-cast technology.

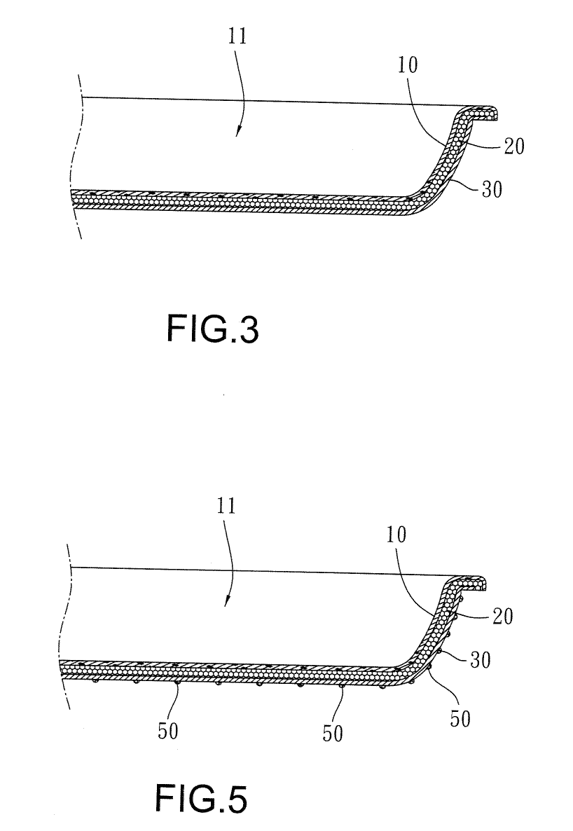

Referring to FIG. 1 and FIG. 3, the automotive foot mat 1 of the present invention is formed primarily with an indented disc-shape body 11, a plane in the indented disk-shaped body 11, which may allow stepping of shoes, such that dirt or sand at shoe soles can be left in the indented disc-shape body 11 due to being brushed out by way of friction on a rough surface, and sand grains or mud can be collected into grooves to facilitate cleaning after being used.

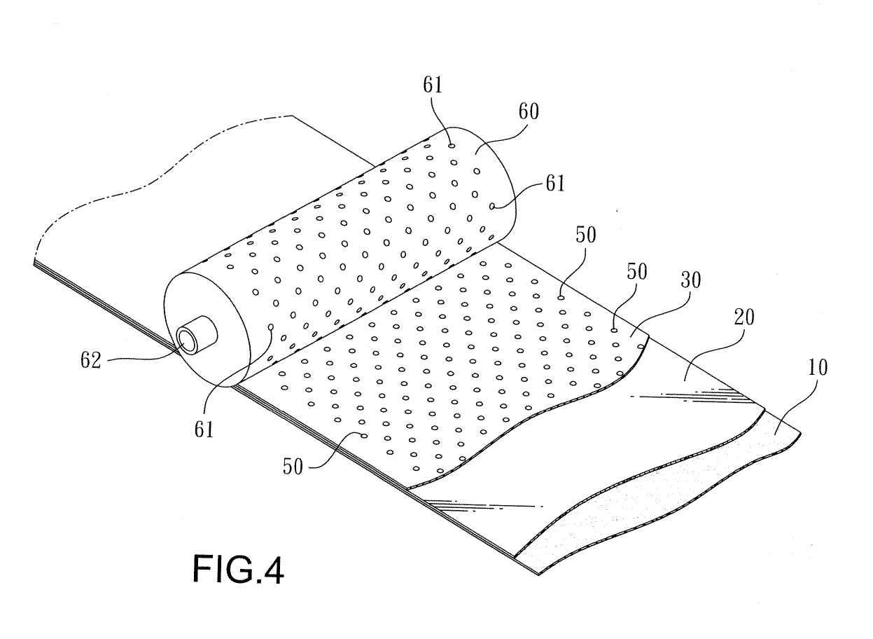

Referring to FIG. 4 and FIG. 5, under the bottom sound absorbing layer 30, it can be further laminated with thermoplastic elastomer to form a skid-proof material 50 of the mat. As shown in FIG. 4, a feeding roller 60 is provided with a plurality of outlets 61, and an entrance 62 at the center of at least one side end, allowing the molten thermoplastic elastomer to be squeezed out from each outlet 61 to be adhered on the sound absorbing layer 30 in dots, such that the skid-proof material 50 can be assembled at a bottom of the sound absorbing layer 30 in grains. As shown in FIG. 5, each grain of the skid-proof material 50 is attached at the bottom of the sound absorbing layer 30, enabling the foot mat to be provided with the skid-proof effect by friction, upon being paved on an automotive carpet. In addition, each grain also allows the bottom surface of the mat to keep at a little spacing, so as to facilitate dehumidifying and drying.

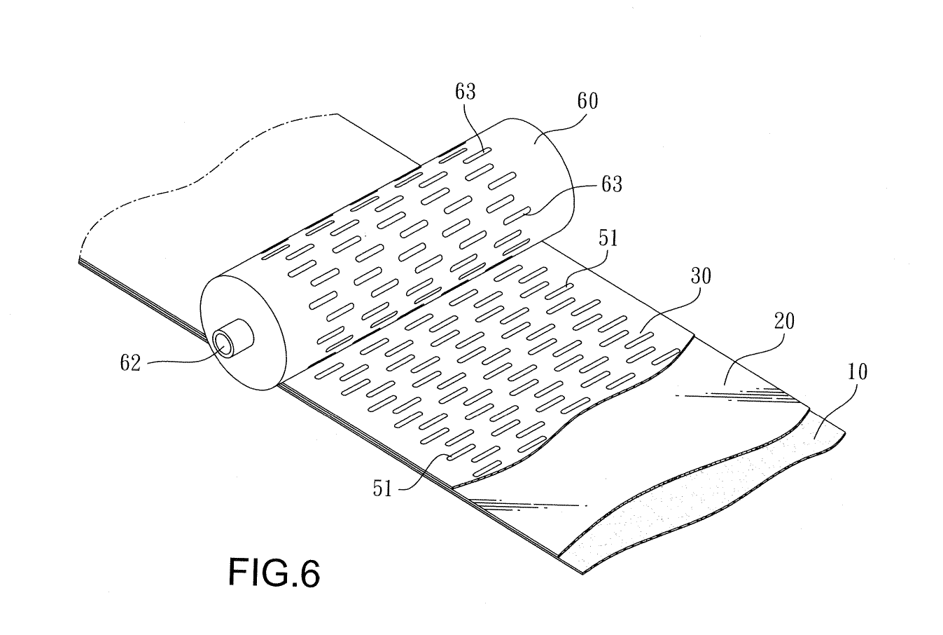

Referring to FIG. 6, by the same principle, if each outlet 63 on the feeding roller 60 is made into a long strip, then the skid-proof material that is squeezed out will be in form of a long strip 51, which is provided with the same good skid-proofing feature.

Accordingly, although the foot mat structure of the present invention is provided with the simple elements, it can be easily produced in a large quantity and can reduce the manufacturing cost, as well as is provided with the advantages of being light-weight, sound insulating, sound absorbing and water-proofed; which is indeed provided with innovation and progressiveness, and can be applied in the production of automotive foot mat or carpet to improve the production efficiency.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A sound insulating and absorbing automotive foot mat structure, comprising at least one upper water-proof layer and one lower sound absorbing layer, wherein the upper water-proof layer is a foaming material, sound absorbing cotton of the lower sound absorbing layer is needle-bonded cotton which is provided with a sound absorbing effect; each layer of parts being attached and made integrally by a die-cast technology, allowing the mat to be provided with multiple functions of sound insulating, vibration buffering, sound absorbing, water-proofing, light weight and inexpensive manufacturing cost.

2. The sound insulating and absorbing automotive foot mat structure according to claim 1, wherein above the water-proof layer, it is further added with a blanket which is made from polypropylene or polyester.

3. The sound insulating and absorbing automotive foot mat structure according to claim 1, wherein above the water-proof layer, it is further added with a blanket which is made from nylon, polyvinyl chloride, plastic or thermoplastic polyolefin.

4. The sound insulating and absorbing automotive foot mat structure according to claim 1, wherein above the water-proof layer is further added with thermoplastic elastomer.

5. The sound insulating and absorbing automotive foot mat structure according to claim 1, wherein the foaming material of the water-proof layer is made from low density polyethylene (LDPE), polyethylene (PE) or ethylene vinyl acetate (EVA).

6. The sound insulating and absorbing automotive foot mat structure according to claim 1, wherein under the bottom layer of sound absorbing layer, it is further laminated with thermoplastic elastomer to form a skid-proof material of the mat.
